(19) United States
(12) Patent Application Publication
(10) Pub. No.: US 2026/0163854 A1
(43) Pub. Date: Jun. 11, 2026

(54) REDACTION OF SENSITIVE INFORMATION IN MULTI-AGENT INTERACTIONS

(71) Applicant: International Business Machines Corporation, Armonk, NY (US)

(72) Inventors: Fernando Luiz Koch, Palm Beach Gardens, FL (US); Alecio Pedro Delazari Binotto, Munich (DE); Francis Powlesland, Muenchen (DE)

(21) Appl. No.: 18/976,726

(22) Filed: Dec. 11, 2024

(51) Int. Cl. H04L 51/212; G06F 21/62; H04L 51/04; H04L 51/224

(52) U.S. Cl. CPC H04L 51/212; G06F 21/6254; H04L 51/04; H04L 51/224

(57) ABSTRACT

A method for redacting sensitive information in a multi-user conversation. The method includes monitoring an ongoing conversation and automatically classifying content into different sensitivity levels based on predefined criteria. The method further includes identifying sensitive information exchanged by one or more users and implementing a rule-based inference to intelligently pause ongoing interactions containing the identified sensitive information when a new user with a clearance level below a threshold is set to join the ongoing conversation. Prior to the new user joining the multi-user conversation, the method includes redacting the identified sensitive information from the ongoing conversation between the one or more users.

### BACKGROUND

The present disclosure relates generally to the field of artificial intelligence (AI), large language models (LLMs), and more particularly to data processing and data privacy in multi-agent interactions.

Consider a scenario where there is an ongoing multi-agent interaction between multiple human users and multiple intelligent agents through digital assistants running on a mobile computing environment. The conversation is ongoing and involves a set of classified information about the process being discussed, where the revealed information should be made available to human and agent users with a certain clearance level or above.

During the process, a new user is arriving to the region where the interaction is happening and is about to onboard the interaction with a given profile that has a lower clearance level than that required for the sensitive information currently being shared.

Currently, there is no way to conceal this sensitive information in a multi-user with multiple clearance level computing environment.

### BRIEF SUMMARY

Embodiments of the present invention disclose a method, a computer program product, and a system.

According to an embodiment, a method, in a data processing system including a processor and a memory, for redacting sensitive information in a multi-user conversation. The method includes monitoring an ongoing conversation and automatically classifying content into different sensitivity levels based on predefined criteria. The method further includes identifying sensitive information exchanged by one or more users and implementing a rule-based inference to intelligently pause ongoing interactions containing the identified sensitive information when a new user with a clearance level below a threshold is set to join the ongoing conversation. Prior to the new user joining the multi-user conversation, the method includes redacting the identified sensitive information from the ongoing conversation between the one or more users.

A computer program product, according to an embodiment of the invention, includes a non-transitory tangible storage device having program code embodied therewith. The program code is executable by a processor of a computer to perform a method. The method includes monitoring an ongoing conversation and automatically classifying content into different sensitivity levels based on predefined criteria. The method further includes identifying sensitive information exchanged by one or more users and implementing a rule-based inference to intelligently pause ongoing interactions containing the identified sensitive information when a new user with a clearance level below a threshold is set to join the ongoing conversation. Prior to the new user joining the multi-user conversation, the method includes redacting the identified sensitive information from the ongoing conversation between the one or more users.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes monitoring an ongoing conversation and automatically classifying content into different sensitivity levels based on predefined criteria. The method further includes identifying sensitive information exchanged by one or more users and implementing a rule-based inference to intelligently pause ongoing interactions containing the identified sensitive information when a new user with a clearance level below a threshold is set to join the ongoing conversation. Prior to the new user joining the multi-user conversation, the method includes redacting the identified sensitive information from the ongoing conversation between the one or more users.

### BRIEF DESCRIPTION OF THE DRAWINGS

FIG. 1 depicts a diagram graphically illustrating the hardware components of a computing environment 100, such as sensitive information redaction computing environment 200, and a cloud computing environment, in accordance with an embodiment of the present invention.

FIG. 2 illustrates sensitive information redaction computing environment 200, in accordance with an embodiment of the present invention.

FIG. 3 is a flowchart illustrating the operation of sensitive information redaction program 220 of FIG. 2, in accordance with an embodiment of the present invention.

### DETAILED DESCRIPTION

In many instances, users in a mobile computing environment have ongoing multi-agent interactions between human users and multiple intelligent agents via digital assistants.

Oftentimes, privileged information may be exchanged between multiple users who have a clearance level to view the privileged information. However, a problem arises when a new user joins the region where the multi-agent interaction is ongoing and is about to onboard the interaction. The new user's profile has a lower clearance than that required for the privileged information currently being shared.

The present innovation includes methods to analyze ongoing multi-agent interactions in a mobile computing environment supported by large language models, identifying sensitive information exchanged and redacting it from the conversation trail to ensure privacy compliance for users with lower clearance levels by masking the identified sensitive information. If a security violation is about to occur, the system employs a rule-based decision supported by large AI models inference to dynamically analyze the ongoing multi-agent interactions, detect sensitive information exchanged, and schedule the redaction of sensitive information, ensuring privacy compliance for users about to onboard but with lower clearance levels.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

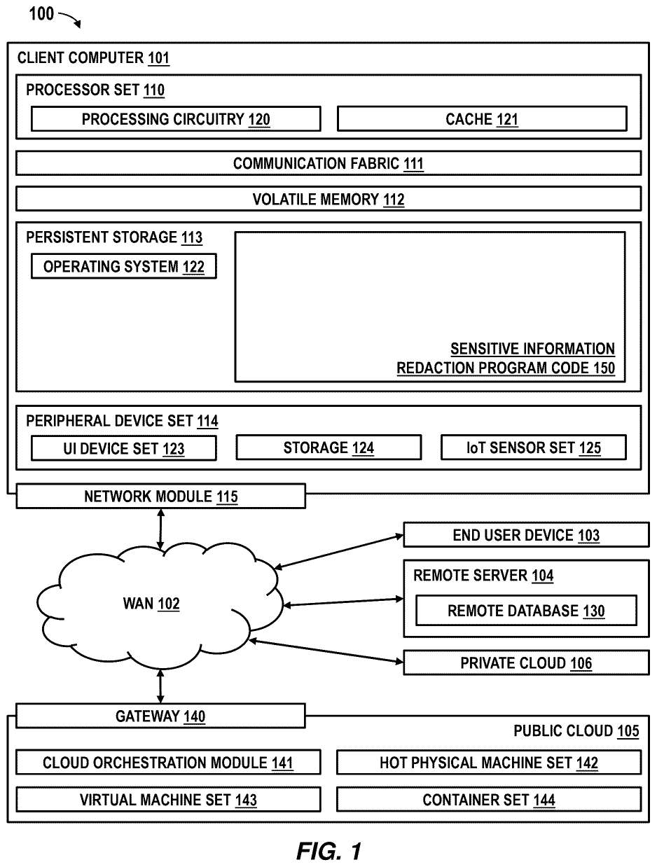

FIG. 1 depicts a diagram graphically illustrating the hardware components of a computing environment 100, such as sensitive information redaction computing environment 200, and a cloud computing environment in accordance with an embodiment of the present invention.

Computing environment 100 contains an example of an environment for the execution of at least some of the computer code involved in performing the inventive methods, such as sensitive information redaction program code 150. In addition to the sensitive information redaction program code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and sensitive information redaction program code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in sensitive information redaction program code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in sensitive information redaction program code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

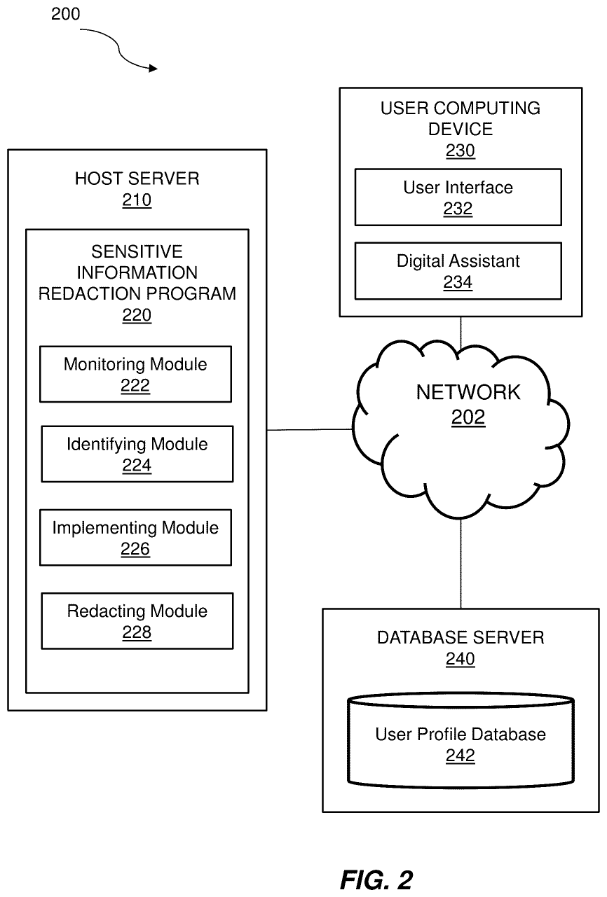

FIG. 2 illustrates sensitive information redaction computing environment 200, in accordance with an embodiment of the present invention. Sensitive information redaction computing environment 200 includes host server 210, user computing device 230, and database server 240, all connected via network 202. The setup in FIG. 2 represents an example embodiment configuration for the present invention and is not limited to the depicted setup to derive benefit from the present invention.

In an exemplary embodiment, host server 210 includes sensitive information redaction program 220. In various embodiments, host server 210 may be a laptop computer, tablet computer, netbook computer, personal computer (PC), a desktop computer, a personal digital assistant (PDA), a smart phone, or any programmable electronic device capable of communicating with user computing device 230 and database server 240 via network 202. Host server 210 may include internal and external hardware components, as depicted, and described in further detail with reference to FIG. 1. In other embodiments, host server 210 may be implemented in a cloud computing environment, as further described in relation to FIG. 1. Host server 210 may also have wireless connectivity capabilities allowing it to communicate with user computing device 230, database server 240, and other computers or servers over network 202.

With continued reference to FIG. 2, user computing device 230 includes user interface 232 and digital assistant 234. In various embodiments, user computing device 230 may be a laptop computer, tablet computer, netbook computer, personal computer (PC), a desktop computer, a personal digital assistant (PDA), a smart phone, a server, a wearable device, or any programmable electronic device capable of communicating with host server 210 and database server 240 via network 202. User computing device 230 may include internal and external hardware components, as depicted, and described in further detail with reference to FIG. 1. In other embodiments, user computing device 230 may be implemented in a cloud computing environment, as described in relation to FIG. 1. User computing device 230 may also have wireless connectivity capabilities allowing it to communicate with host server 210, database server 240, and other computers or servers over network 202.

In exemplary embodiments, user computing device 230 includes user interface 232, which may be a computer program that allows a user to interact with user computing device 230 and other connected devices via network 202. For example, user interface 232 may be a graphical user interface (GUI). In addition to comprising a computer program, user interface 232 may be connectively coupled to hardware components, such as those depicted in FIG. 1, for sending and receiving data. In an exemplary embodiment, user interface 232 may be a web browser, however in other embodiments user interface 232 may be a different program capable of receiving user interaction and communicating with other devices, such as host server 210, in a single user or multi-user computing environment.

In exemplary embodiments, user interface 232 may be a touch screen display, a visual display, a remote operated display, or a display that receives input from a physical keyboard or touchpad. In alternative embodiments, user interface 232 may be operated via voice commands or by any other means known to one of ordinary skill in the art.

In exemplary embodiments, user computing device 230 includes digital assistant 234, which may be a software program capable of being run on a user mobile device, such as user computing device 230.

In exemplary embodiments, digital assistant 234 is a software application designed to assist a user in a wide variety of tasks. Also known as virtual assistants, digital assistants are widely used in various capacities. For example, a digital assistant 234 can help users quickly book appointments, refill prescriptions, create content, and so forth.

In exemplary embodiments, digital assistants 234 exist in various types of devices and services used every day, such as smartphones, tablets, TVs, cars, home appliances, speakers, as well as weather, navigation, banking, and other mobile applications. Digital assistants 234 combine technologies like AI and natural language processing (NLP) to understand spoken or written language, discern user intent, access relevant information, and work seamlessly in different devices and services.

In exemplary embodiments, multiple users may have an interaction through some conversation media (i.e., digital assistant 234, chat bot, or some other similar textual communication media) where the interactions contain classified data. Oftentimes, a new user can onboard the conversation with a lower-level security clearance and should not have access to confidential information that is displayed on the conversation trail.

In exemplary embodiments, database server 240 includes user profile database 242. In various embodiments, database server 240 may be a laptop computer, tablet computer, netbook computer, personal computer (PC), a desktop computer, a personal digital assistant (PDA), a smart phone, a server, or any programmable electronic device capable of communicating with host server 210 and user computing device 230 via network 202. Database server 240 may include internal and external hardware components, as depicted and described in further detail with reference to FIG. 1. In other embodiments, database server 240 may be implemented in a cloud computing environment, as described in relation to FIG. 1. Database server 240 may also have wireless connectivity capabilities allowing it to communicate with host server 210, user computing device 230, and other computers or servers over network 202.

In exemplary embodiments, user profile database 242 contains various user profiles with corresponding security clearance levels. For example, user profile database 242 may include a company's list of employees (i.e. organizational chart) with matching security clearance permissions, granted/revoked security permissions, user preferences, conversation histories of a user, and so forth.

While user profile database 242 is depicted as being stored on database server 240, in other embodiments, user profile database 242 may be stored on user computing device 230, host server 210, sensitive information redaction program 220, or any other device or database connected via network 202, as a separate database. In alternative embodiments, user profile database 242 may be comprised of a cluster or plurality of computing devices, working together, or working separately.

With continued reference to FIG. 2, host server 210 includes sensitive information redaction program 220. Host server 210 may be a laptop computer, tablet computer, netbook computer, personal computer (PC), a desktop computer, a personal digital assistant (PDA), a smart phone, or any programmable electronic device capable of communicating with user computing device 230 and database server 240, via network 202.

With continued reference to FIG. 2, sensitive information redaction program 220, in an exemplary embodiment, may be a computer application on host server 210 that contains instruction sets, executable by a processor. The instruction sets may be described using a set of functional modules. In exemplary embodiments, sensitive information redaction program 220 may receive input from user computing device 230 and database server 240 over network 202. In alternative embodiments, sensitive information redaction program 220 may be a computer application on user computing device 230, or a standalone program on a separate electronic device.

The present invention revolves around leveraging rule-based inference and large AI models to infer ongoing multi-agent interactions, detecting sensitive information exchanged, dynamically scheduling the redaction of such information prior to onboarding lower clearance users, and ensuring privacy compliance and security integrity in mobile computing environments.

With continued reference to FIG. 1, the functional modules of sensitive information redaction program 220 include monitoring module 222, identifying module 224, implementing module 226, and redacting module 228.

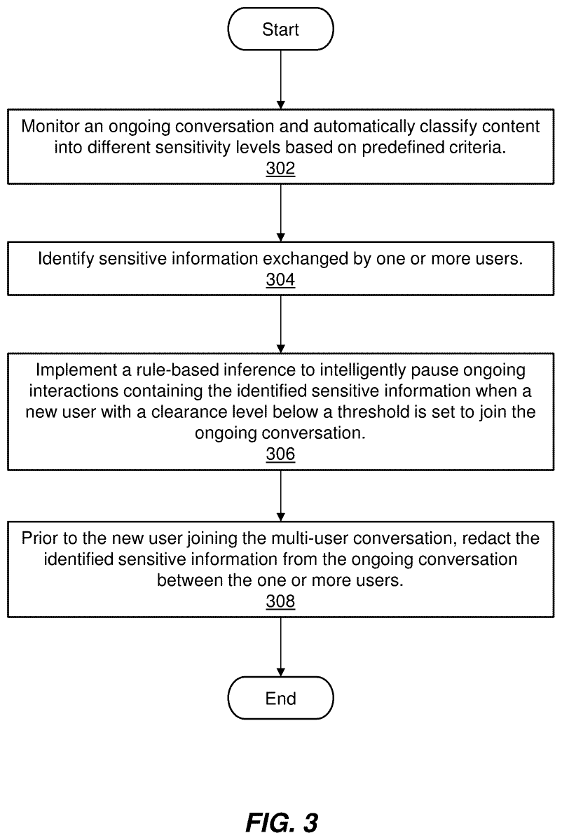

FIG. 3 is a flowchart illustrating the operation of sensitive information redaction program 220 of FIG. 2, in accordance with embodiments of the present disclosure.

With reference to FIGS. 2 and 3, monitoring module 222 includes a set of programming instructions, in sensitive information redaction program 220, to monitor an ongoing conversation and automatically classify content into different sensitivity levels based on predefined criteria (step 302). The set of programming instructions is executable by a processor.

In exemplary embodiments, monitoring module 222 is capable of continuously monitoring the content of conversations within a multi-agent digital environment to identify and classify sensitive information.

In exemplary embodiments, monitoring module 222 implements AI models to monitor all ongoing conversations. The predefined criteria associated with the different sensitivity levels may include public information, confidential information, secret information, and so forth.

In exemplary embodiments, the AI models are trained on a dataset of text with annotations for various levels of sensitivity to accurately detect and categorize sensitive information.

In further exemplary embodiments, monitoring module 222 may include an opt-in feature, enabling a user to set preferences (e.g., give or revoke permissions) for detection, monitoring, and identifying a user's location.

With reference to an illustrative example, consider there is an ongoing conversation through a chat interface where multiple human users are interacting with one, or multiple, bots supported by large generative models. Further consider that the conversation is ongoing for a lengthy period and involves messages with sensitive content. There are also programming interfaces to allow capturing, editing, and inserting messages in this conversation. Monitoring module 222 implements machine learning (ML) models to classify and detect sensitive information according to predefined categories (e.g., personal data, classified business details, and so forth). Monitoring module 222 continuously monitors, or scans, the conversation transcripts to identify sensitive content.

In further exemplary embodiments, monitoring module 222 infers the onboarding timeline for new users within the mobile environment. The method applies rule-based inference, and potentially, large AI models to predict when the new users are likely to join the ongoing conversation by analyzing the geographical data, historical interaction patterns, and other relevant factors.

Further, monitoring module 222 adaptively adjusts the timing of onboarding notifications to coincide with an anticipated arrival of the new user and determines when the ongoing conversation can safely resume or whether additional redaction is necessary.

In alternative embodiments, monitoring module 222 determines a propensity of a user to join the ongoing conversation by integrating historical and real-time data about typical movement patterns and phone interaction behavior of the new user.

In further exemplary embodiments, monitoring module 222 predicts an optimal window period for when the new user is likely to join the ongoing conversation, based on historical data supplied from the new user, and issues a notification to join the ongoing conversation, based on the determined propensity to join and the optimal window period for the new user.

With continued reference to FIGS. 2 and 3, identifying module 224 includes a set of programming instructions in sensitive information redaction program 220, to identify sensitive information exchanged by one or more users (step 304). The set of programming instructions is executable by a processor.

In exemplary embodiments, identifying module 224 utilizes a rule-based algorithm to continuously verify the clearance level of the one or more users in real-time, wherein the rule-based algorithm checks user profiles against a database of clearance levels (i.e., user profile database 242) to ensure that the one or more users only access content appropriate for the clearance level of the user.

In exemplary embodiments, the database of user profile clearance levels may be updated in real-time based on administrative changes or policy updates.

In further exemplary embodiments, when identifying module 224 identifies sensitive content that does not align with a user's clearance level, an automated redaction algorithm is implemented to obscure or remove text, replace sensitive terms with less specific terms, or completely block message content from being displayed to the one or more users. The redaction mechanism adapts dynamically to the flow of the conversation, ensuring that no sensitive information leaks outside of authorized circles.

In exemplary embodiments, identifying module 224 determines the clearance level of the one or more users in the ongoing conversation and the new user about to join the conversation and employs rule-based algorithms to redact portions of the sensitive information based on the clearance level of the one or more users and the new user.

Identifying module 224 updates, dynamically, the ongoing conversation to reflect the redacted portions of the sensitive information.

With continued reference to an illustrative example for recommending redacted content for a specific user, consider that there is a model to continuously monitor the content of conversations within a multi-agent digital environment to identify and classify sensitive information. Further consider that there is a model equipped with advanced security features to manage user data according to varying clearance levels and ensure compliance with privacy laws and regulations. Based on the identified sensitive information and identified clearance level of a user, sensitive content is identified that does not align with a user's clearance level and an automated redaction algorithm is implemented.

With continued reference to FIGS. 2 and 3, implementing module 226 includes a set of programming instructions in sensitive information redaction program 220, to implement a rule-based inference to intelligently pause ongoing interactions containing the identified sensitive information when a new user with a clearance level below a threshold is set to join the ongoing conversation (step 306). The set of programming instructions is executable by a processor.

Further, implementing module 226 uses large AI models to assess the context of the conversation to predict what information needs to be redacted based on the security clearance of any new, or existing, participants. Additionally, implementing module 226 updates the conversation environment to reflect these redactions, ensuring that only authorized users have access to classified information.

In exemplary embodiments, implementing module 226 implements a feedback loop with the one or more users to report any issues with the automated redaction algorithm. For example, issues with the automated redaction algorithm may include over-redaction or under-redaction, which could either block essential information or expose sensitive data.

Further, implementing module 226 uses the feedback to continuously train and improve the AI models (i.e., automated redaction algorithms) responsible for monitoring and redacting content.

In further exemplary embodiments, sensitive information redaction program 220 can implement a comprehensive logging system that records all instances of redaction and user access to sensitive content, which may be stored in database server 240. This system helps in auditing and compliance tracking to ensure that all data handling adheres to legal and organizational standards.

In alternative embodiments, sensitive information redaction program 220 can generate automated reports for internal review and for compliance with external regulatory requirements, detailing how sensitive information is managed and protected.

In alternative embodiments, implementing module 226 utilizes predictive models to estimate the time required for a new user to onboard based on their movement patterns (if applicable) and digital behavior. Implementing module 226 informs the adaptation system about when the conversation can safely resume or when additional redaction might be necessary.

With continued reference to an illustrative example for context-aware onboarding timeline in mobile computing environments, consider that there is collected data about a user's mobile device to understand the user's physical movements and proximity to conversation interface or context to prompt them into a multi-agent content interaction. Further consider that there are historical interaction patterns, inferred from the user's past behavior within the mobile environment, such as typical login times, frequent locations of interaction, and duration of past engagements. Additional user contextual data, such as a user's calendar, traffic conditions, or public transport schedules which could influence their movement patterns. Implementing module 226 implements the context-aware onboarding through (1) data integration and analysis, (2) predictive modeling, (3) a context-aware trigger system, and (4) user notification and interface adaptation.

In exemplary embodiments, implementing module 226 applies an algorithm to integrate real-time and historical data sources to create a comprehensive profile of each user's typical interaction patterns and current contextual situation and implements a rule-based inference with support from ML models to analyze the integrated data using advanced analytics to understand how factors such as current location, time of day, and external conditions might influence the user's timing and likelihood of joining the conversation.

In alternative embodiments, implementing module 226 implements predictive models using ML techniques to estimate when a user is likely to access the conversation interface based on their current movement patterns and historical interaction data.

Implementing module 226 further implements a rule-based system that uses the output from the predictive models to trigger notifications, or prompts, for the user to join the conversation at the optimal time. The model must account for variables like expected arrival times and potential delays, adjusting the onboarding prompts accordingly.

In alternative embodiments, implementing module 226 implements a notification system that informs the user of the ideal time to join the conversation, based on the predictive insights and contextual triggers. Further, implementing module 226 may implement an algorithm to adapt the user interface dynamically to accommodate the predicted onboarding time, thus ensuring a seamless integration into the ongoing multi-agent interaction.

With continued reference to FIGS. 2 and 3, redacting module 228 includes a set of programming instructions in sensitive information redaction program 220, to redact the identified sensitive information from the ongoing conversation between the one or more users prior to the new user joining the multi-user conversation (step 308). The set of programming instructions is executable by a processor.

In exemplary embodiments, redacting module 228 checks the clearance level of the new user against a required clearance level to join the ongoing conversation and triggers a redaction protocol if the clearance level of the new user is lower than a required clearance level.

In exemplary embodiments, the real-time redaction algorithm is implemented through a combination of rule-based inference and large generative models to identify and obscure sensitive text entries, removing messages from the view of certain users, or substituting sensitive terms with generalized descriptions.

In further exemplary embodiments, redacting module 228 implements a retroactive redaction algorithm, wherein the retroactive redaction algorithm comprises revisiting a conversation history and applying the redaction protocol to messages containing the sensitive information prior to the new user joining the conversation. The retroactive redaction algorithm ensures that previous exchanges that the new user can access do not contain sensitive information.

In exemplary embodiments, network 202 is a communication channel capable of transferring data between connected devices and may be a telecommunications network used to facilitate telephone calls between two or more parties comprising a landline network, a wireless network, a closed network, a satellite network, or any combination thereof. In another embodiment, network 202 may be the Internet, representing a worldwide collection of networks and gateways to support communications between devices connected to the Internet. In this other embodiment, network 202 may include, for example, wired, wireless, or fiber optic connections which may be implemented as an intranet network, a local area network (LAN), a wide area network (WAN), or any combination thereof. In further embodiments, network 202 may be a Bluetooth network, a WiFi network, or a combination thereof. In general, network 202 can be any combination of connections and protocols that will support communications between host server 210, user computing device 230, and database server 240.

1. A computer-implemented method for redacting sensitive information in a multi-user conversation, comprising:
monitoring an ongoing conversation and automatically classifying content into different sensitivity levels based on predefined criteria;
identifying sensitive information exchanged by one or more users;
implementing a rule-based inference to intelligently pause ongoing interactions containing the identified sensitive information when a new user with a clearance level below a threshold is set to join the ongoing conversation; and
prior to the new user joining the multi-user conversation, redacting the identified sensitive information from the ongoing conversation between the one or more users.

2. The computer-implemented method of claim 1, further comprising:
inferring when the new user will join the ongoing conversation based on movement patterns of the new user within the mobile computing environment, wherein movement patterns comprise geographical data and historical digital interaction patterns of the new user;
adaptively adjusting timing of onboarding notifications to coincide with an anticipated arrival of the new user; and
determining when the ongoing conversation can safely resume or whether additional redaction is necessary.

3. The computer-implemented method of claim 1, further comprising:
determining the clearance level of the one or more users in the ongoing conversation and the new user about to join the conversation;
employing rule-based algorithms to redact portions of the sensitive information based on the clearance level of the one or more users and the new user; and
updating, dynamically, the ongoing conversation to reflect the redacted portions of the sensitive information.

4. The computer-implemented method of claim 1, further comprising:
checking the clearance level of the new user against a required clearance level to join the ongoing conversation; and
triggering a redaction protocol if the clearance level of the new user is lower than a required clearance level.

5. The computer-implemented method of claim 4, further comprising:
implementing a retroactive redaction algorithm, wherein the retroactive redaction algorithm comprises revisiting a conversation history and applying the redaction protocol to messages containing the sensitive information prior to the new user joining the conversation.

6. The computer-implemented method of claim 1, further comprising:
determining a propensity to join the ongoing conversation by integrating historical and real-time data about typical movement patterns and phone interaction behavior of the new user;
predicting an optimal window period for when the new user is likely to join the ongoing conversation, based on historical data supplied from the new user; and
issuing a notification to join the ongoing conversation, based on the determined propensity to join and the optimal window period for the new user.

7. The computer-implemented method of claim 1, further comprising:
utilizing a rule-based algorithm to continuously verify the clearance level of the one or more users in real-time, wherein the rule-based algorithm checks user profiles against a database of clearance levels to ensure that the one or more users only access content appropriate for the clearance level of the user; and
implementing an automated redaction algorithm to obscure or remove text, replace sensitive terms with less specific terms, or completely block message content from being displayed to the one or more users.

8. The computer-implemented method of claim 7, further comprising:
implementing a feedback loop with the one or more users to report any issues with the automated redaction algorithm; and
training and improving, continuously, the automated redaction algorithm responsible for monitoring and redacting the message content.

9. A computer program product, comprising a non-transitory tangible storage device having program code embodied therewith, the program code executable by a processor of a computer to perform a method, the method comprising:
monitoring an ongoing conversation and automatically classifying content into different sensitivity levels based on predefined criteria;
identifying sensitive information exchanged by one or more users;
implementing a rule-based inference to intelligently pause ongoing interactions containing the identified sensitive information when a new user with a clearance level below a threshold is set to join the ongoing conversation; and
prior to the new user joining the multi-user conversation, redacting the identified sensitive information from the ongoing conversation between the one or more users.

10. The computer program product of claim 9, further comprising:
inferring when the new user will join the ongoing conversation based on movement patterns of the new user within the mobile computing environment, wherein movement patterns comprise geographical data and historical digital interaction patterns of the new user;
adaptively adjusting timing of onboarding notifications to coincide with an anticipated arrival of the new user; and
determining when the ongoing conversation can safely resume or whether additional redaction is necessary.

11. The computer program product of claim 9, further comprising:
determining the clearance level of the one or more users in the ongoing conversation and the new user about to join the conversation;
employing rule-based algorithms to redact portions of the sensitive information based on the clearance level of the one or more users and the new user; and
updating, dynamically, the ongoing conversation to reflect the redacted portions of the sensitive information.

12. The computer program product of claim 9, further comprising:
checking the clearance level of the new user against a required clearance level to join the ongoing conversation; and
triggering a redaction protocol if the clearance level of the new user is lower than a required clearance level.

13. The computer program product of claim 12, further comprising:
implementing a retroactive redaction algorithm, wherein the retroactive redaction algorithm comprises revisiting a conversation history and applying the redaction protocol to messages containing the sensitive information prior to the new user joining the conversation.

14. The computer program product of claim 9, further comprising:
determining a propensity to join the ongoing conversation by integrating historical and real-time data about typical movement patterns and phone interaction behavior of the new user;
predicting an optimal window period for when the new user is likely to join the ongoing conversation, based on historical data supplied from the new user; and
issuing a notification to join the ongoing conversation, based on the determined propensity to join and the optimal window period for the new user.

15. The computer program product of claim 9, further comprising:
utilizing a rule-based algorithm to continuously verify the clearance level of the one or more users in real-time, wherein the rule-based algorithm checks user profiles against a database of clearance levels to ensure that the one or more users only access content appropriate for the clearance level of the user; and
implementing an automated redaction algorithm to obscure or remove text, replace sensitive terms with less specific terms, or completely block message content from being displayed to the one or more users.

16. The computer program product of claim 15, further comprising:
implementing a feedback loop with the one or more users to report any issues with the automated redaction algorithm; and
training and improving, continuously, the automated redaction algorithm responsible for monitoring and redacting the message content.

17. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
monitoring an ongoing conversation and automatically classifying content into different sensitivity levels based on predefined criteria;
identifying sensitive information exchanged by one or more users;
implementing a rule-based inference to intelligently pause ongoing interactions containing the identified sensitive information when a new user with a clearance level below a threshold is set to join the ongoing conversation; and
prior to the new user joining the multi-user conversation, redacting the identified sensitive information from the ongoing conversation between the one or more users.

18. The computer system of claim 17, further comprising:
inferring when the new user will join the ongoing conversation based on movement patterns of the new user within the mobile computing environment, wherein movement patterns comprise geographical data and historical digital interaction patterns of the new user;
adaptively adjusting timing of onboarding notifications to coincide with an anticipated arrival of the new user; and
determining when the ongoing conversation can safely resume or whether additional redaction is necessary.

19. The computer system of claim 17, further comprising:
determining the clearance level of the one or more users in the ongoing conversation and the new user about to join the conversation;
employing rule-based algorithms to redact portions of the sensitive information based on the clearance level of the one or more users and the new user; and
updating, dynamically, the ongoing conversation to reflect the redacted portions of the sensitive information.

20. The computer system of claim 17, further comprising:
checking the clearance level of the new user against a required clearance level to join the ongoing conversation; and
triggering a redaction protocol if the clearance level of the new user is lower than a required clearance level.
